(19) United States
(12) Patent Application Publication
(10) Pub. No.: US 2016/0165671 A1
(43) Pub. Date: Jun. 9, 2016

(54) Hydrotron Super Electric Water Heater

(71) Applicant: Tasos Aggelopoulos, Honolulu, HI (US)

(72) Inventor: Tasos Aggelopoulos, Honolulu, HI (US)

(21) Appl. No.: 14/559,648

(22) Filed: Dec. 3, 2014

(51) Int. Cl. H05B 6/10; F24H 1/14

(52) U.S. Cl. CPC H05B 6/108; F24H 1/142

(57) ABSTRACT

A system for electrical heating applications generating intense heat for steam boilers and all other water heating applications that employs a transformer having a spindle core with extensions on each side constructed in the center of the transformer. A hole is bored in length through the center of the steel frame from one end to the other with a steel rod suspended within it. Two conically wound primary coils facing one another are wrapped around both sides of the spindle, and two secondary coils are wound around the extended shaft next to each apex of the spindle. A voltage is applied to the adjoining leads of the primary coils with an inline potentiometer to regulate the applied current. The poles of the secondary coils are connected to an external induction coil assembly with a centering steel shaft for generating intense heat. A flow switch sensor is threaded onto one side of the system to allow the flow of water upon turning the valve integrated in faucets at the point of use. Water passes through the system, gets heated, and then passes through the induction coil assembly to be heated intensely. The system is 600% more efficient than all other conventional methods of converting electrical energy to heat.

The present U.S. patent application claims the priority filing date of U.S. Provisional Patent Application Ser. No. 61/963,493 filed on Dec. 6, 2013.

### FIELD OF INVENTION

The present novel invention relates to a system for using electricity in generating heat, steam, and hot water, particularly for replacing the conventional method of converting electrical energy, hydrocarbon, and fossil fuels to heat in steam turbine engines, commercial boilers, residential water heaters, space and hydronic heating systems and all other applications where intense heat is required.

### BACKGROUND OF THE INVENTION

It has previously been proposed that electricity can be used alone or used with hydrocarbon and/or a fossil fuel air mixture for fuel-fired heating applications particularly in steam engines, commercial boilers and residential water heaters. Proposals that seek to avoid the use of complex mechanisms, unnecessary electronic circuitries, and conventional methods of converting electrical energy to heat have generally called for an efficient electrical system to generate intense heat that can feed itself and produce surplus electricity for steam turbine engines and usage in all other heating applications

such as commercial boilers, residential water heaters, and/or point of use tankless water heaters. One such proposal includes U.S. Patent 20090092384 to Shimin Luo and Yongbing Ding, issued Apr. 9, 2009, disclosed using a coil wrapped around a pipe in which there is an induction heating element using high frequency resonance to generate an electromagnetic field and purge the induction heating element within the pipe to generate additional heat.

Another proposal includes the publication of U.S. Pat. No. 7,945,146B2 to Carlos Antonio Cabrena, issued May 17, 2011, disclosed a tankless water heater composed of programmable microprocessors, series of electronics, and more than one heating element in an effort to reduce the loss of electrical energy by 20% to 30% as opposed to standard methods of hot water heaters.

Another proposal includes the publication of U.S. Patent 2012/0145,807 to Martinez Marta, published Jun. 14, 2012, disclosed the use of a heating element enclosed in a sealed compartment attached directly to the shower head. The system claims to raise the temperature of the flowing water 18° F. continuously at best.

Another proposal includes the publication of U.S. Patent application 2012/0063755 to inventors Brian Lucker and Jeff Hankins, published Mar. 15, 2012, disclosed the use of a removable heating element comprised of a continuous coil with the end forming a loop around a shank. Seemingly, they have used the concentration of the electromagnetic field to purge the shank.

The prior art proposals have had significant disadvantages in terms of conventional methods of assembling heating elements, winding coils cylindrically, and making clumsy calculations by using complex mechanisms and unnecessary electronic gadgets to regulate the supply of electrical energy. It would be highly desirable to provide a simple and scalable mechanism using the right scientific method by winding the electrical coils conically to work in cohesion of the working order of geometry of space and the law of octave of elements of matter which compress magnetic fluxes in inverse and direct cube

ratio in each octave progression, that may generate a continuous supply of intense heat at any temperature desirable for usage in heating apparatuses. It would be further desirable to provide a simple mechanism that can reduce the cost of electrical energy, manufactured at low costs, and eliminate the cost of unnecessary plumbing labor and materials. Manufacturing a new type of water faucet with an integrated potentiometer, having one input and output port water line, allows for opening another line of water faucet accessories. This will add up to the world market resources and the wealth of the planet. This will also reduce the amount of space needed for water pipe lines and fulfills the demand of World Energy Conservation Organizations.

### SUMMARY OF THE INVENTION

In accordance with the present invention, a system for heating water and generating steam adapted for use in commercial boilers, residential hot water heaters, and steam boilers employs a rectangular step-down transformer heating system with two conically wound primary coils and two secondary coils facing each other into which water passes from a flow switch at one side of the frame of said transformer to be heated and exits from the other side of the frame. The water then passes through an external assembly of an induction coil heating element for further heating. Two conically shaped steel cores that face one another are constructed within the transformer. A hole that allow for the passage of water has been drilled through the center of the core, running in length from one side of the transformer to the other side of it. A water supply pipe is attached to the flow switch whereat the other side of the transformer is threaded to a water supply pipe and connected to an assembly of two heating elements of induction coils. A soft, highly resistant steel rod is suspended in the center of the core of the transformer. The diameter of the steel rod is smaller than the diameter of the hole to allow for the passage of water through the hole. Two primary coils are conically wound around the cores. One side of the coil is wound in a clockwise direction and the other is wound in a counter-clockwise direction. The coils have a voltage applied across the positive and the negative leads to multiply the electrical potential by thrusting the

magnetic fluxes inwardly from without to compress, whereat purging the centering steel rod and transferring power onto the secondary coils. There are two secondary coils at the far ends of each primary coil. One of them is also wound in a clockwise direction and the other is wound in a counter-clockwise direction. A potentiometer is integrated within each valve of a point of use faucet. When a user turns on any water faucet or valve from any point of use, the flow switch activates the system. The centering rod purges to state of incandescent heat resulting from the compression of the magnetic fluxes generated by conically winding the coils in compliance to the geometry of space and the law of octave of elements of matter. Hot water passes through the transformer then exits from the other side of it to flow through an assembly of two induction coils for further heating. When the user shuts the valve off, the flow switch shuts down the system, and the transformer is deactivated.

In a preferred embodiment, the two adjoining leads of the bases of the primary coils that are facing one another are connected together and plugged into a negative lead of an electrical outlet socket. The other two far side apex leads of the primary coils are also connected together and plugged into the positive lead of an electrical outlet socket.

A soft steel rod suspended in the center of the hole of the transformer is purged by the electrical potential that is created by the compression of the magnetic fluxes at each octave progression by conically winding the primary coils.

In a preferred embodiment, the positive and the negative poles of the secondary coils are connected to an external assembly of an induction coil. A shower head or faucet can be affixed directly to the end of the assembly.

An external assembly is comprised of two induction coils facing one another and is conically wound nine cycle turns at 60° inclinations in compliance with the geometry of space and the law of octave of elements of matter. The left induction coil is wound in a clockwise direction and the right induction coil is wound in a counter-clockwise direction

to create the maximum amount of magnetic power without violating nature's one way direction. The two adjoining leads of the bases of the induction coils are attached to the negative poles of the secondary coils, and the two outside leads of the apexes of the induction coils are attached to the positive poles of the secondary coils. A soft, highly resistant steel shaft is suspended in the center of the two induction coils and is extended throughout the length of both of the induction coils. When the system is activated, the induction coils are heated and the compression of the magnetic fluxes, which they produce in octave progression, purges the centering steel shaft and turns the two ends of the shaft, where the current collides at the apexes, into an incandescent state. This assembly is encased in a tightly fit cover with water supply pipes threaded to each end of the casing.

The induction coil assembly can be constructed in many different sizes to fit the required applications, and the poles of the secondary coils can be extended to any length to be connected with the assembly of the induction coils so that they may fit the required placement or point of use for any type of application.

In a preferred embodiment, the steel cores of the transformer are constructed conically at 60° inclinations, where the primary coils are also conically wound around them at 60° inclinations. An insulated steel spacer sits at the end of each primary coil to separate them from the secondary coils. The secondary coils are wound at one cycle turn only at the far ends of each primary coil.

In a preferred embodiment, a layer of a strong, thin heat resistant coating is applied below and above the primary and the secondary coils. The air has been vacuumed from them in a vacuum chamber. Heated liquid helium is then pumped into the vacuous space via a petcock. The liquid helium prevents the coils from burning themselves out by the immense heat that they generate.

Hot water exits the transformer and then flows through the induction coil assembly to be heated further. The hot water can then be directed to the point of use without reverting to store it in a tank.

As may be required for the intended capacity of generating an immense amount of heat for usage in steam boilers, multiple Hydrotron systems can be assembled together in a series to generate super dry steam for usage in steam turbine engines.

For the construction of such applications, an inline water circulation pump circulates the water through a closed circulation loop. Water is fed through one side of the Hydrotron system and passed through as many systems as needed to attain the required temperature. The steam is then fed into a steam boiler tank wherein the assembly of the induction coils is integrated with the tank. The steam is then super heated and pumped into a steam turbine engine where it passes into a condenser to turn the steam back to water. The inline pump pushes the water through the Hydrotron systems for the water to turn to steam again.

The system is scalable to fit any required size of application and performs 600% more efficiently in reducing the cost of electrical energy than the other existing electrical and fuel-fired heating apparatuses on the market. In addition, the invention eliminates the cost of unnecessary services and maintenance of electronic gadgets and complex mechanisms. Also, this system eliminates the cost of unnecessary labor and materials.

Other objects, features, and advantages of the present invention will be explained in the following detailed description of the invention having reference to the appended drawing.

### BRIEF DESCRIPTION OF DRAWING

FIG. 1 is a schematic diagram illustrating a system in accordance with the present invention for an electric water heater adapted for use in commercial boilers, point of use residential hot water heaters and steam engines.

FIG. 2 is a schematic diagram illustrating a preferred embodiment for the construction of a transformer frame with its core crafted conically at a 60° inclination from the apexes to their bases. A hole is bored through the length of the frame from one end to the other end with a steel rod suspended within it.

FIG. 3 is a diagram illustrating a preferred embodiment of two primary and two secondary coils facing one another. The left primary and secondary coils are wound in a clockwise direction, and the right primary and secondary coils are wound in a counter-clockwise direction.

FIG. 4A is a diagram illustrating a preferred embodiment of an insulated spacer which separates the primary coils from the secondary coils.

FIG. 4B is a diagram illustrating a preferred embodiment of a method of winding a primary coil and a secondary coil around a ductal iron 6412-14 core to be used for soldering and other welding applications.

FIG. 4C is a diagram illustrating a preferred embodiment of a method of winding a primary coil and a secondary coil around a ductal iron 6412-14 core to be used in bathroom showerheads and kitchen faucets.

FIG. 5A is a diagram illustrating a preferred embodiment of the transformer's enclosure with liquid helium pumped into it via a petcock.

FIG. 5B is a diagram illustrating a preferred embodiment of a strong vacuum sealed, non-conductive ceramic coating below and above the primary and secondary coils.

FIG. 6 is a schematic circuit diagram of an electrical circuit for powering a pump, primary coils, secondary coils, water flow switch, potentiometer, heat sensor, and induction coils.

FIG. 7 is a diagram illustrating the concentration of magnetic fluxes and the electrical potential of octave progressions in direct cube ratio for each octave of the primary coils.

FIG. 8 is a diagram illustrating a preferred embodiment of a completed system for connecting all the electrical leads of the primary coils, secondary coils, and the induction coils.

FIG. 9 is a diagram illustrating a preferred embodiment of two induction coils. The left induction coil is wound in a clockwise direction, and the right induction coil is wound in a counter-clockwise direction with a steel shaft suspended in the center of the coils.

FIG. 10 is a diagram illustrating a preferred embodiment of the method of winding all the layers of the primary coils.

FIG. 11 is a diagram illustrating a preferred embodiment of a water flow switch threaded to the side of the transformer's frame.

### DETAILED DESCRIPTION OF THE INVENTION

In the following detailed description of the present invention, certain preferred embodiments are illustrated providing specific details of implementation. The principles of invention are deemed to have broad applications to conically winding electrical coils for usage in electrical heating applications. Those skilled in the art will recognize that other variations, equivalents and modifications may be made given the disclosed principles of the invention.

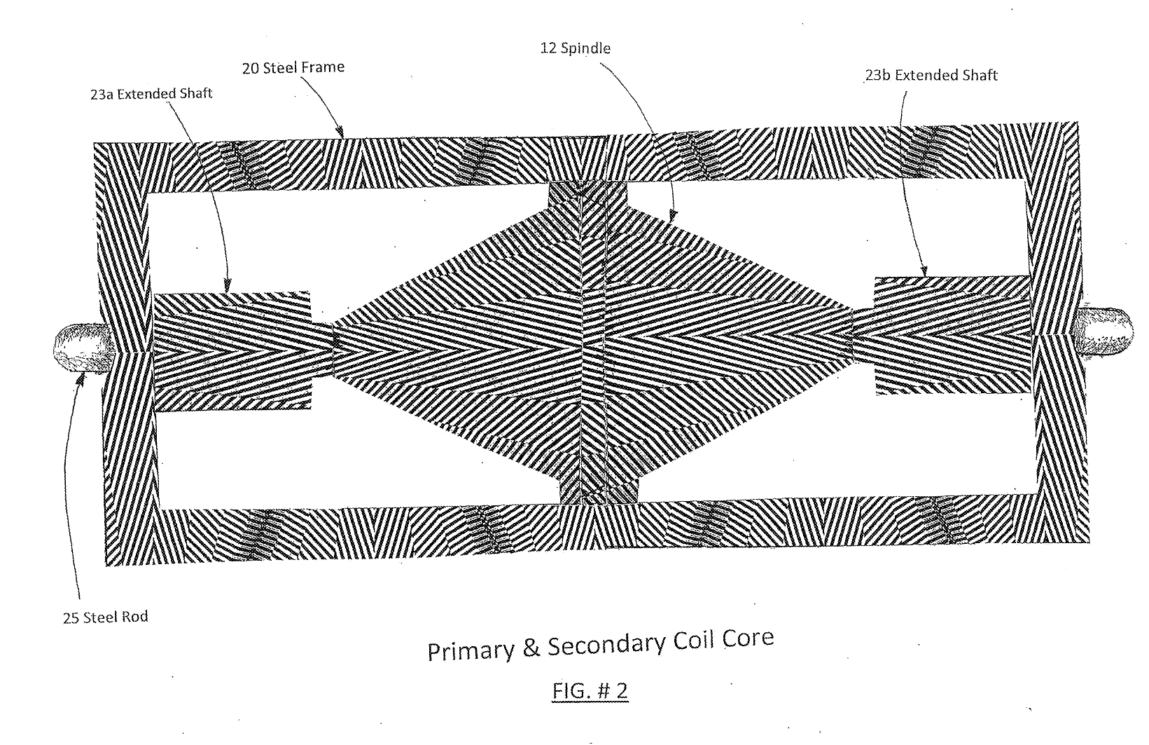

An overall architecture for a system in accordance with the present novel invention is described below for achieving an intense amount of heat by conically winding coils adapted for use in water heaters and steam turbine engines. The system is described as particularly adapted for use in residential point of use water heaters. Referring to FIG. 2, a rectangular steel frame 20 is made of ductal iron 6412-14 with ½″ (12.7 mm) thick walls. Its length is 8″ (203.2 mm) long and is measured from the inside; its width is 2½″ (63.5 mm) wide and is also measured from the inside and has height is 2½″ (63.5 mm). A conically shaped spindle 12 is positioned at the center of the transformer. Both sides of the spindle 12 are crafted at 60° inclinations from the apexes to the bases. Two extended shafts 23a and 23b, both measuring 1½″ (38.1 mm) in length and 1¼″ (31.75 mm) in diameter, are attached on each side of the spindle 12. The spindle 12 and its extensions 23a and 23b are made of ductal iron 6412-14.

The diameter of the center of the spindle 12 is 2½″ (63.5 mm) and measures 5″ (127 mm) from end to end. The spindle 12 with its extensions 23a and 23b sits directly in the center of the steel frame 20. A hole is bored through the length of the center of the steel frame. The diameter of the hole is ½″ (12.7 mm), and it is coated with non corrosive stainless steel material to prevent the surface of the hole from accumulating iron oxide and other molten minerals in the water. A steel rod 25 is also made of ductal iron 6412-14, measuring 8″ (203 mm) in length and ⅜″ (9.5 mm) in diameter, is suspended in the center of the hole 24. The steel rod 25 is also coated with noncorrosive stainless steel material to prevent sedimentation.

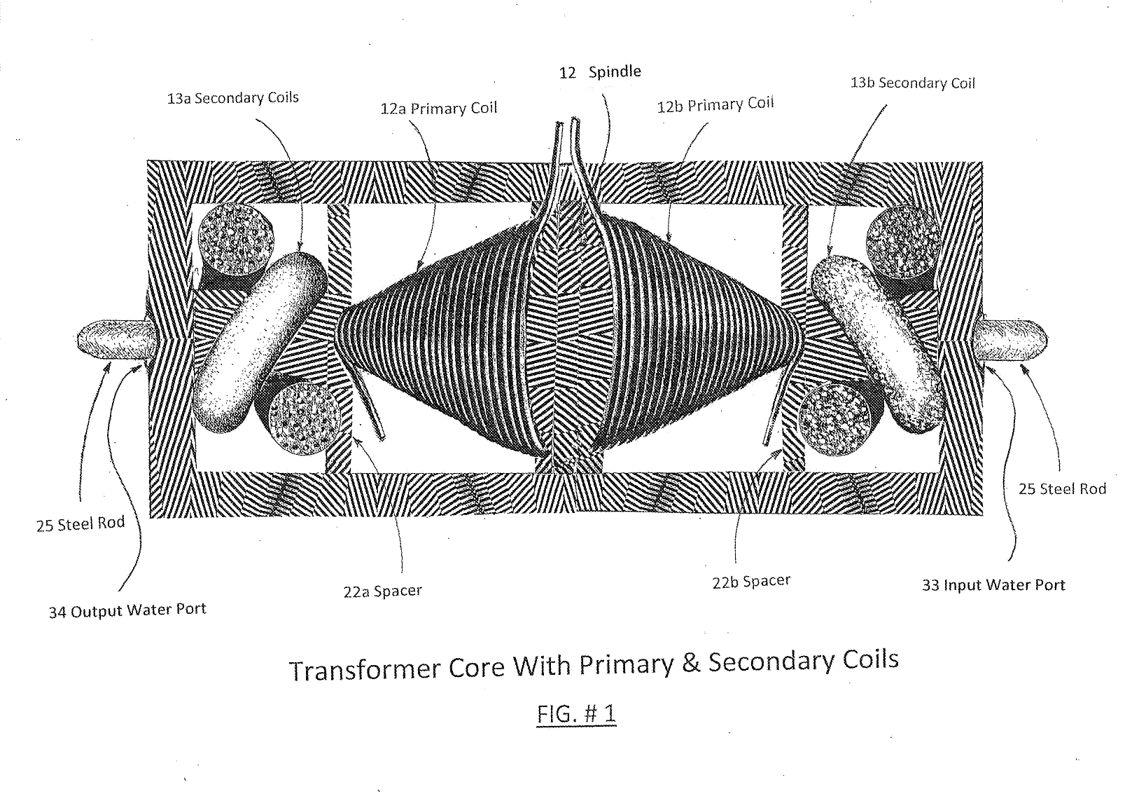

Referring to FIG. 1, two conically wound primary coils 12a and 12b are made of magnet wire gauge #10. They are wound conically at 60° inclinations around both sides of the spindle 12. The primary coil 12a on the left side of the spindle 12 is wound in a clockwise direction with ten layers winding at twenty cycle turns per layer. The primary coil 12b on the right side of the spindle 12 is wound in a counter-clockwise direction with ten layers winding at twenty cycle turns per layer.

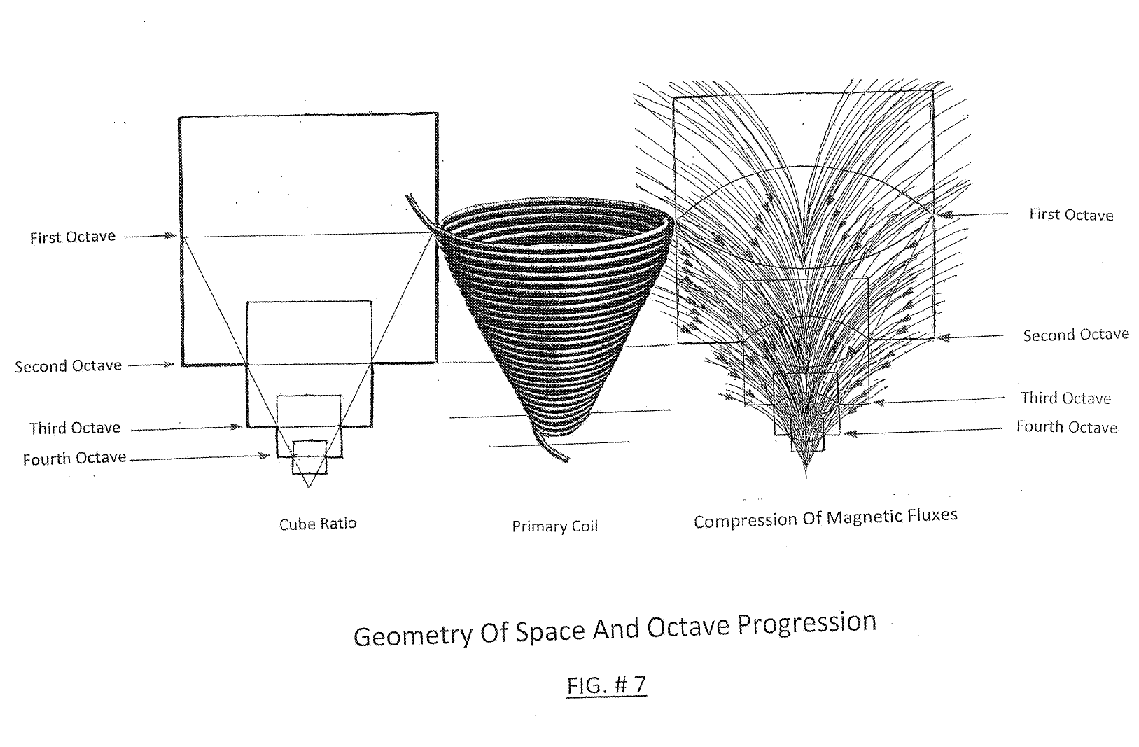

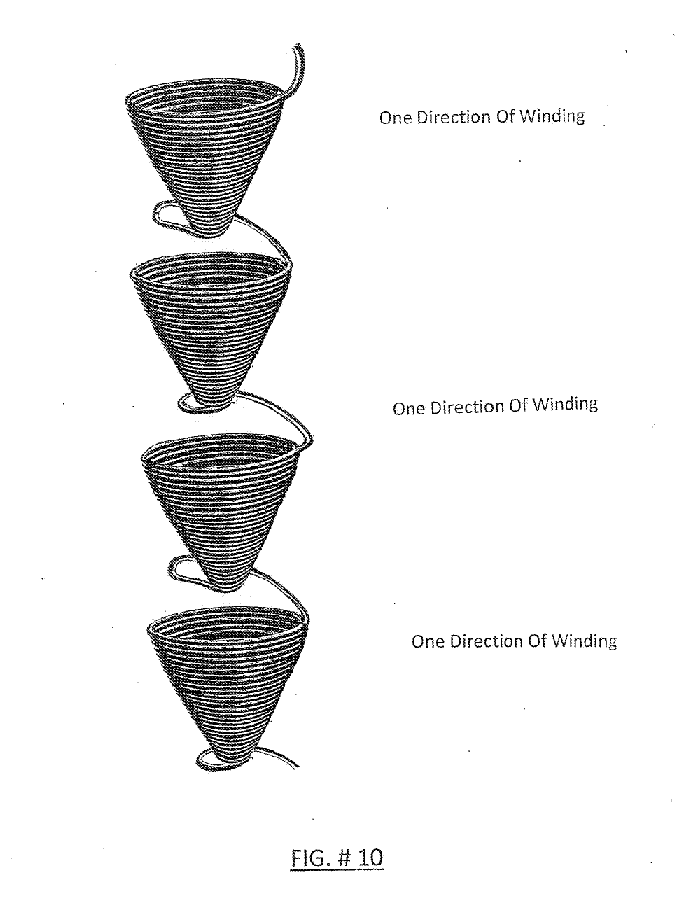

The method of winding these primary coils 12a and 12b are significantly important as opposed to the conventional method of winding coils cylindrically. Referring to FIG. 10, the direction of the winding is always the same for all layers. The first layer must begin winding at the base of the coil to the apex of the coil, and then continues to wind onto the base of the second layer until it reaches the apex again. Referring to FIG. 7, all other layers must continue to be wound based on the same premise to maximize compression of the magnetic fluxes of each layer from the North “base” to the South “apex”. The direction of the magnetic fluxes of each layer is influenced by the direction of the flow of electrical current and the direction of the winding of the primary coils.

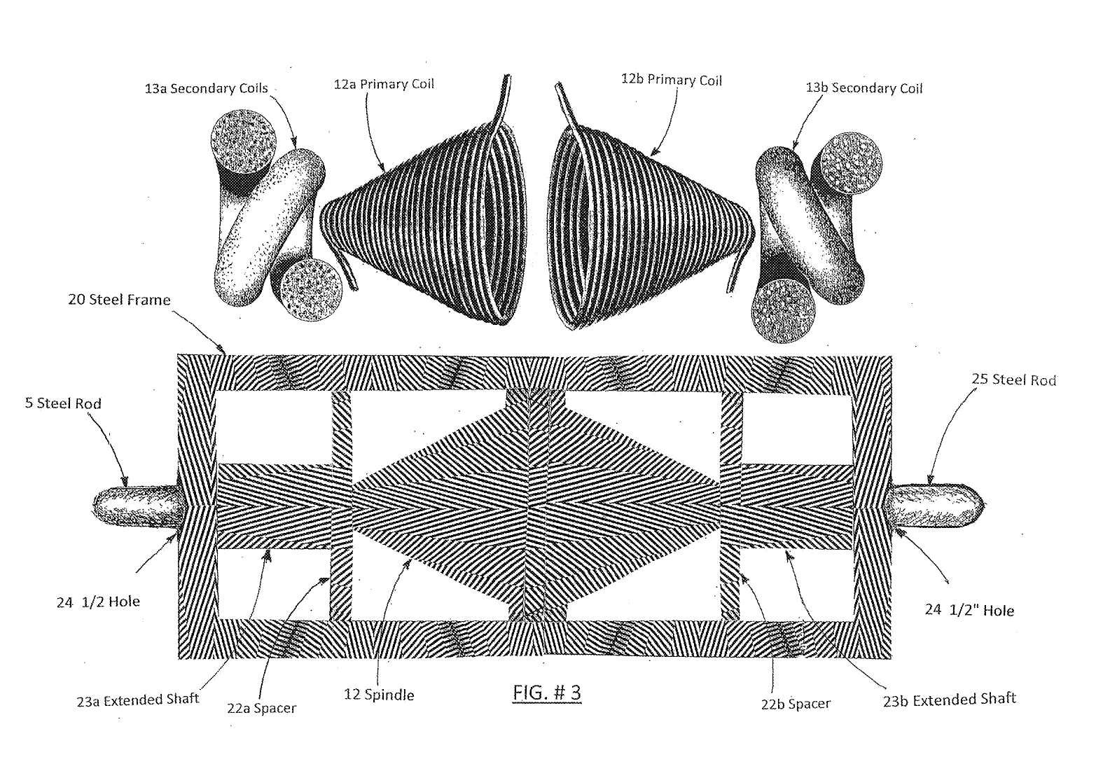

Referring to FIG. 3, insulated spacers 22a and 22b are placed at the ends of each apex of the primary coils 12a and 12b. They are ¼″ (6.35 mm) thick and 2½″ (63.5 mm) by 2½″ (63.5 mm) square and are made of ductal iron 6412-14. The insulated spacers keep the primary coils 12a and 12b separated from the secondary coils 13a and 13b, while allowing the transfer of power from the primary coils 12a and 12b to the secondary coils 13a and 13b.

Two secondary coils 13a and 13b are wrapped around each side of the extended shafts 23a and 23b. Referring to FIG. 3, these coils are thick gauge #2 stranded copper cables that are capable of handling a high amperage load. The secondary coil 13a on the left side is wound in a clockwise direction at one cycle turn while the secondary coil 13b on the right side is wound in a counter-clockwise direction at one cycle turn.

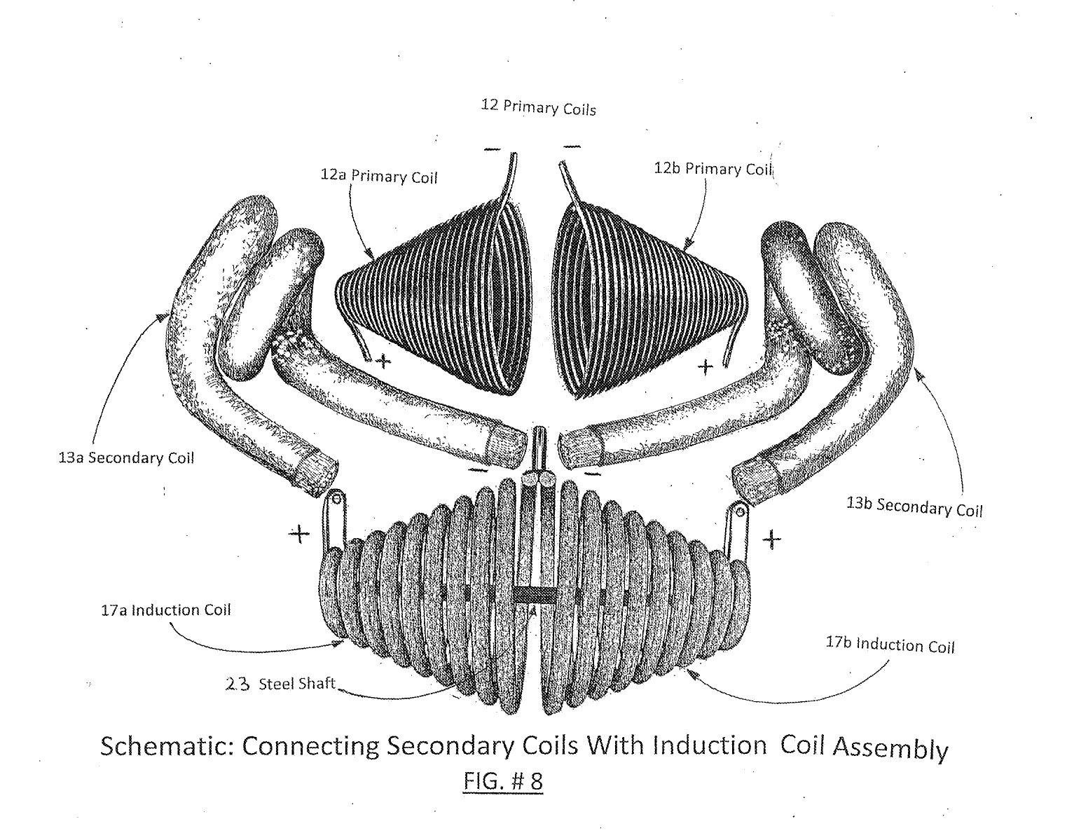

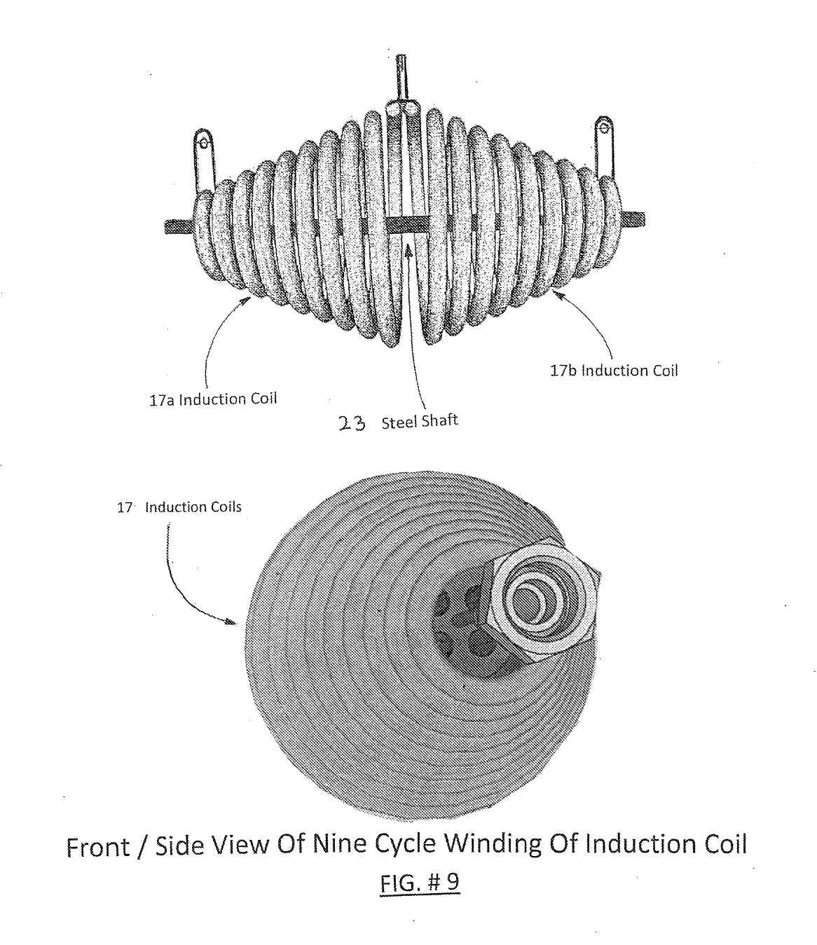

Referring to FIG. 9, an induction coil assembly 17 is comprised of two conically wound induction coil heating elements 17a and 17b that are ⅜″ (9.5 mm) diameter in thickness. The induction coils 17a and 17b are conically wound nine cycle turns at 60° inclinations. The left induction coil 17a is wound in a clockwise direction, and the right induction coil 17b is wound in a counter-clockwise direction to create the maximum amount of magnetic power without violating nature's one way direction. The diagram FIG. 9 shows how these two coils are wound. They are made of soft iron steel. The diagram FIG. 8 shows how the secondary coils 13a and 13b are connected to the induction coil assembly 17.

Referring to FIG. 9, a soft iron steel shaft is suspended lengthwise in the center of the induction coils extending a ½″ (12.7 mm) beyond the apexes of the two induction coils 17a and 17b. Resulting from the concentration of the magnetic fluxes upon the center of the shaft, the two ends of the shaft turn to an incandescent state of heat in response to the concentration of the magnetic fluxes at the fourth octaves of the apexes of the induction coils where the currents collide.

All conically wound coils are at 60° inclinations creating the first, second, third, and fourth octave positions as indicated in FIG. 7. The positioning of the octaves account for the octave multiplying power that the windings of the primary coils 12a and 12b and the windings of the induction coils 17a and 17b are created to fulfill. These four focal octaves are the square and the cube in inverse and direct ratio of the distance from each other. They create the elements of magnetism and heat as well as the spectrum of color which is the measure of heat.

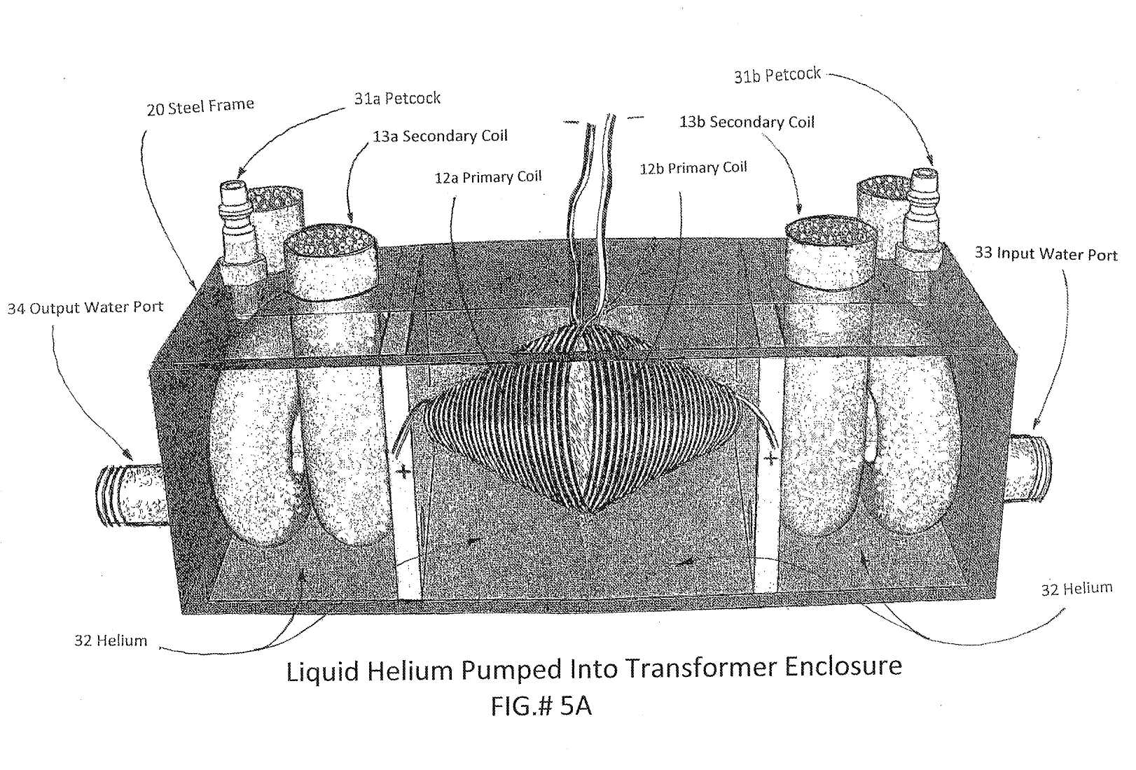

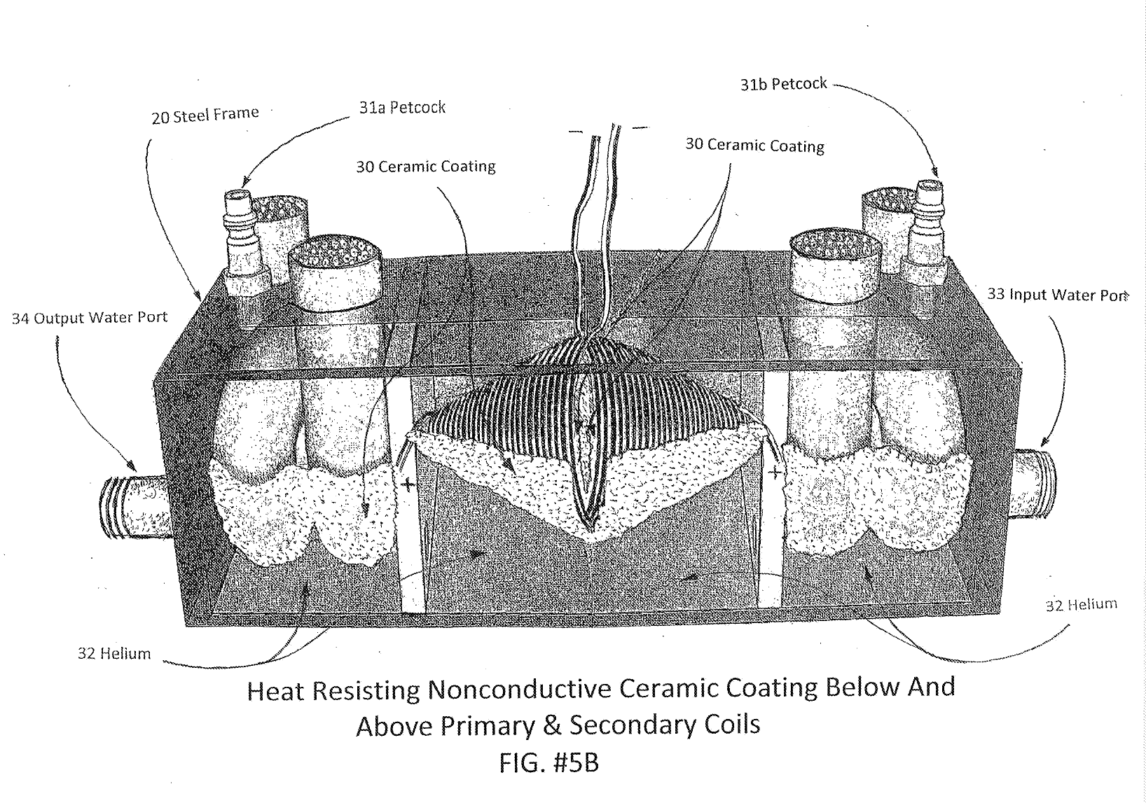

Referring to FIG. 5, an insulating thin ceramic high heat resistant coating is crafted above and below the primary coils 12a and 12b and secondary coils 13a and 13b. The spaces in between the coating have been vacuumed in a vacuum chamber. A petcock 31a and 31b is placed on top of each side of the transformer for pumping heated liquid helium 32 into it. Liquid Helium prevents all of the coils from burning themselves out from the intense heat that each coil creates.

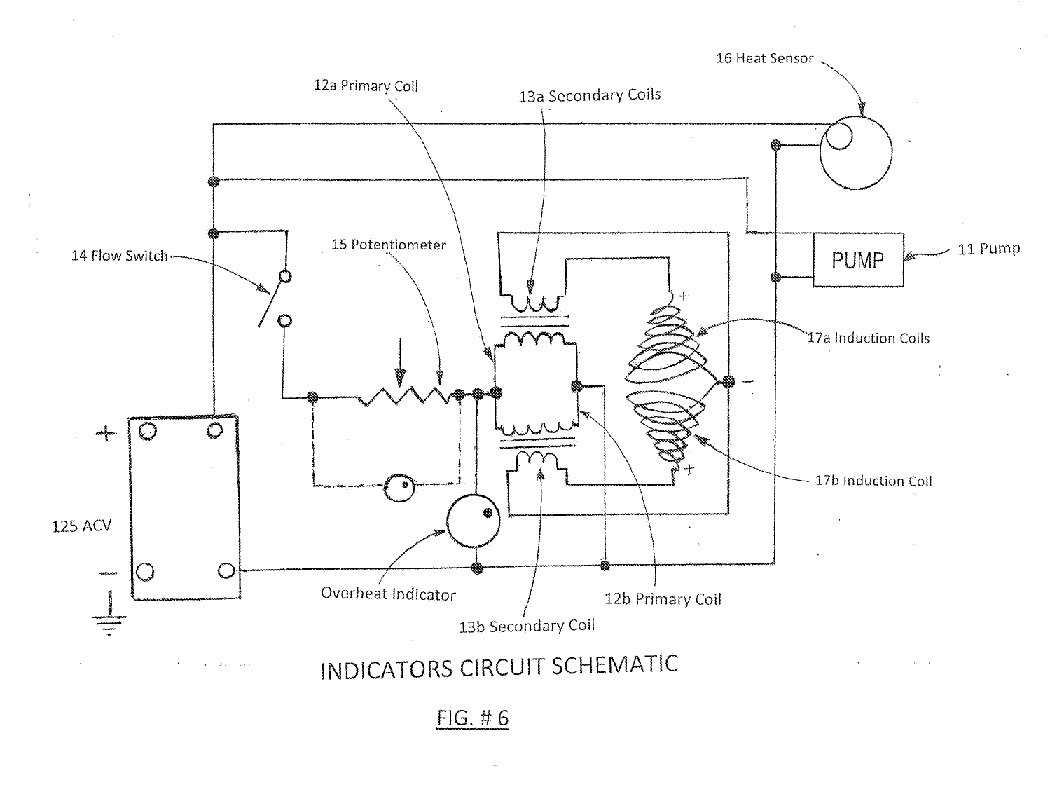

Referring to diagram FIG. 6, a potentiometer 15 is integrated within each valve of the point of use faucet. A user can adjust the flow of the water by shifting the handle of the valve to the side and adjust the temperature of the water by pulling the handle inwardly or outwardly. The leads of the potentiometer 15 are connected inline with the positive leads of the primary coils 12a and 12b.

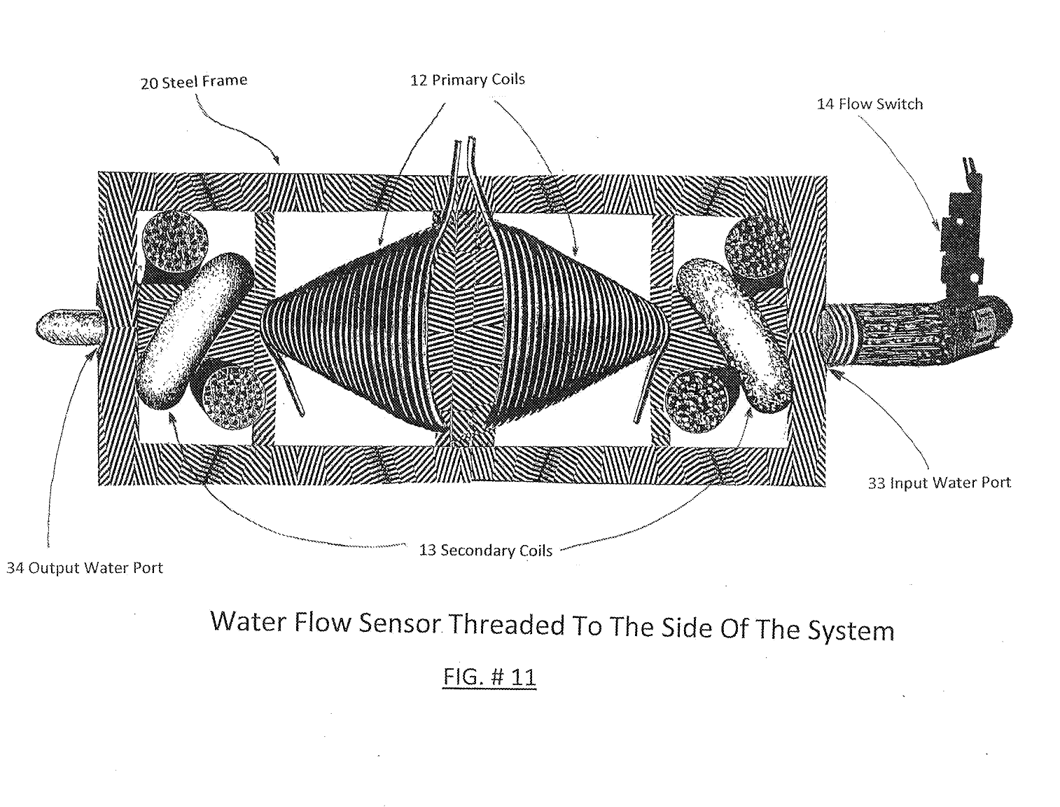

Referring to FIG. 11, a water flow switch 14 is threaded to the input water port 33 at the right side of the steel frame 20. Upon the use of water from any point of use faucet, the flow switch sensor 14 will allow the passage of water through the steel frame 20 to be heated. The water then flows to the assembly of the induction coils 17 via a water supply line to flow through, around, and in between the windings of the induction coils 17a and 17b to be heated intensely. The water then exits the steel frame 20 from the output water port 34.

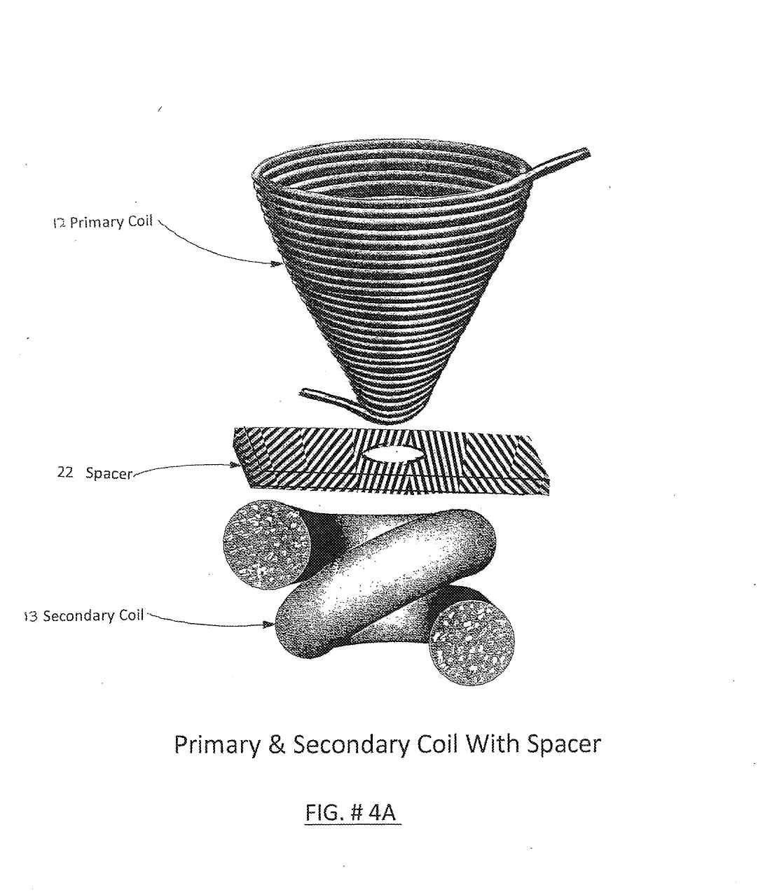

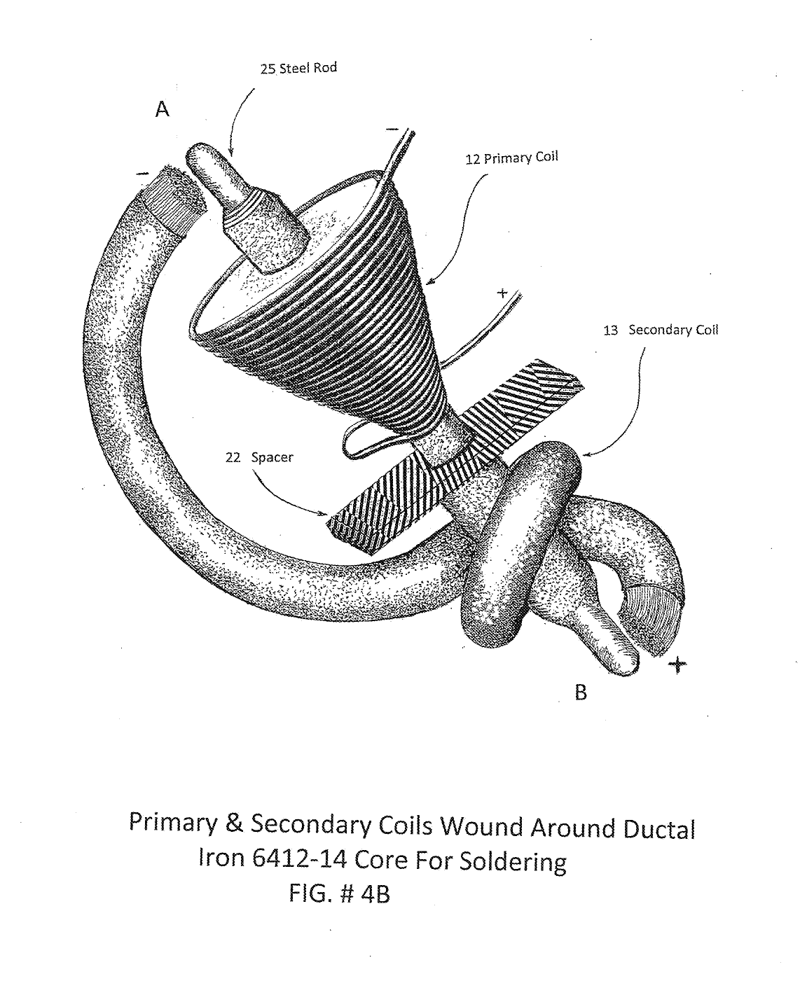

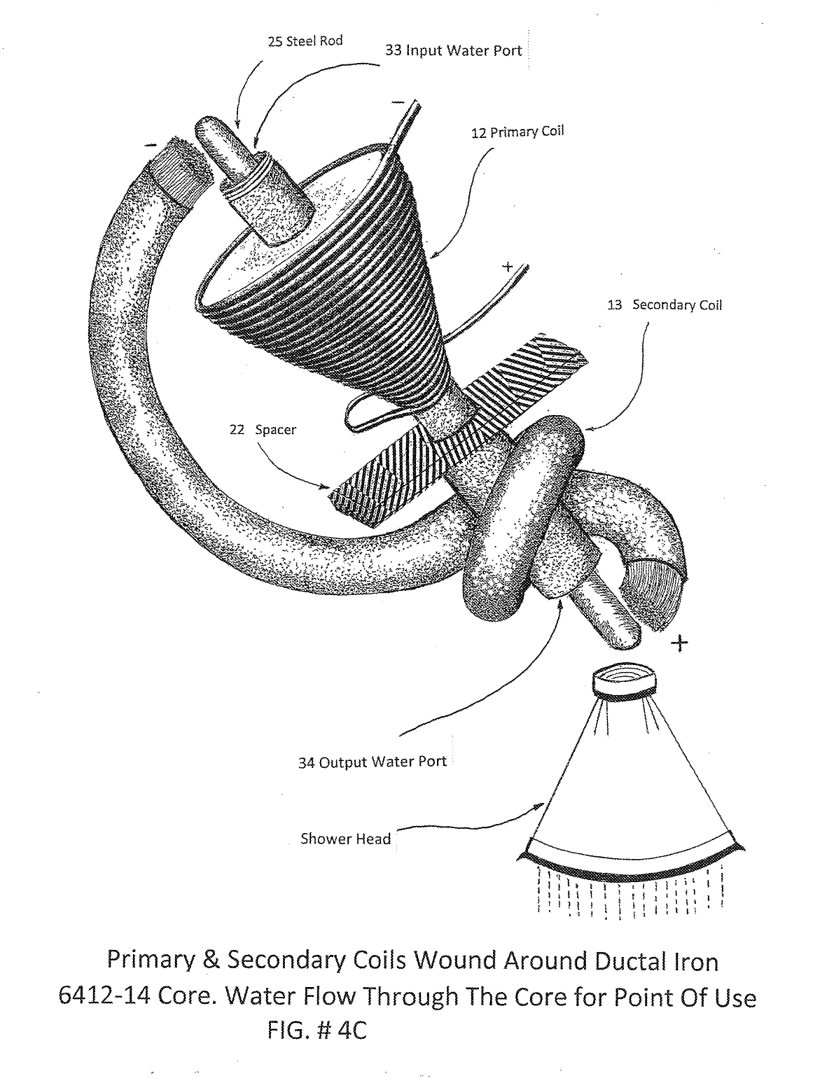

Referring to FIG. 4C, the system requires the construction of only one input water port 33 and one output water port 34. A user may select cold water by simply shifting the handle of the valve to the side. A user may also select any desirable temperature setting at the moment of use by pulling the handle to the preferred setting.

Referring to FIG. 4B, a primary coil and a secondary coil are wound around a ductal iron 6412-14 core. A potentiometer is integrated into the trigger switch of the soldering iron. A user is able to select a desirable heat setting by pressing the switch whereat the entirety of the ductal iron becomes an induction heating element. The negative pole 13 of the secondary coil is connected to point A of the ductal iron core, and the positive pole of the secondary coil 13 is connected to point B of the ductal iron core. The power of compression of the electrical potential and the concentration of the magnetic fluxes transferred onto the secondary coil reaches 640 Amps resulting in an intense, spontaneous state of heat at point B where the currents collide.

As may be required for the intended capacity of heating a greater volume of water, several Hydrotron systems can be assembled in a series or simply construct a larger system that is capable of handling a higher amount of electrical current.

### One Liter Water Container Example

The Hydrotron super electric water heater system was tested on a one liter container of water. The system was plugged into a wall outlet socket having an output of 125 VAC at 6 Amps. We constructed a closed circuit whereat an inline 12 VDC water pump circulated one liter of water through the system as well as the one liter container. On average, the hot water heater uses 5 KW of electricity to raise the temperature of one liter of water in one minute from 85° F. to 155° F. With the Hydrotron system, the temperature of the water in the container was raised from 85° F. to 155° F. in one minute using only 125 VAC at 6 Amps (750 watts). The one liter container of water continued to be tested with the system for several days and repeatedly produced the same result. The system was found to be capable of reducing electrical usage by up to 600%.

### Seven Gallon Water Tank Example

The Hydrotron super electric water heater system was tested on a seven gallon water tank. An inline 12 VDC water pump circulated the water in a closed circuit loop through the system. A copper coil heat exchanger was adapted in a series with the induction coil assembly. The system was plugged into a wall outlet socket having an output of 125 VAC at 20 Amps. We activated the system and allowed the water circulation pump to keep the water circulating for three minutes. The temperature of the water in the tank was raised from 85° F. to 155° F. The result was a 600% increase in performance in comparison to conventional ten gallon hot water tanks that operate on electrical power.

### Fifty Gallon Water Heater Tank Example

The Hydrotron super electric water heater was tested on a conventional fifty gallon tank electrical water heater. We terminated the existing heating element and cut the bottom of the tank to insert the induction coil assembly in order for it to sit in the bottom of the tank. An in line 12 VDC pump was used to circulate the water through the system and into the induction coil assembly in the water tank. A voltage of 125 VAC at 30 Amps was applied to the primary coils of the system while the water was circulated. The temperature of the water in the tank was raised from 85° F. to 155° F. in twenty five minutes. Conventional fifty gallon tank electric water heaters use 9 KW of electricity and take forty five minutes to raise the temperature of the water from 85° to 125° F.

### Space and Under-Laymen Heating Example

The Hydrotron super electric water heater system was tested on constructed zigzag pipes simulating a Hydronic heating system with an inline radiator and a 12 VDC water pump to heat the space as well as the under-laymen pipes. An amount of ten gallons of water was used and circulated throughout the system during the test. The system was plugged into a wall outlet socket having 125 VAC at 20 Amps. We circulated the water in the system for four minutes. The temperature of the water in the radiator was raised from 85° F. to 145° F.

### Soldering Gun Example

The Hydrotron super electric water heater system can be productively used in soldering and welding equipment. Referring to FIG. 4B, the system was a hand crafted soldering gun that was comprised of only one conically wound primary coil and one secondary coil. The system was tested on a twenty five cent U.S. coin (quarter). The coin was turned into a red incandescent state of heat in two seconds, then yellow and finally white nearly instantaneously. The system was also plugged into a wall outlet socket having 125 VAC at 10 Amps.

The above tests showed that the Hydrotron super electric water heater system can operate more effectively at a lower electrical current density to produce the required efficiency from a smaller amount of electricity as compared to prior art tests and devices.

It is to be understood that many modifications and variations may be devised given the above described principles of the invention. It is intended that all such modifications and variations be considered as within the spirit and scope of this invention, as defined in the following claims.

1. An electrical system for heating water in all commercial and residential water heating applications comprises:
a rectangular transformer with a conically constructed core in which water passes through the center of the system to be heated and then passes through an inline induction coil assembly for further heating; for use on the water return circulations of the said system and to the point of use, or the hot water is simply returned via a water return line into a return port at the side of the system.
a flow switch sensor is threaded onto the water entry port from one side of the system which allows the flow of water through the system upon the use of the water faucet.
wherein two primary coils are conically wound around the core of the system with two secondary coils wound at far ends of the primary coils and a spacer is inserted to keep the primary coils and the secondary coils separated.
wherein the primary coils have voltage applied across the positive and the negative leads to heat the core of the system into an incandescent state of heat.
wherein this method of winding multiplies the electrical potential and compresses the magnetic fluxes creating intense heat
wherein the secondary coils are attached to the induction coil assembly to further heat the flow of the water.
wherein a hole running through the length of the system has a steel rod heating element suspended within the hole. Its diameter is smaller than the diameter of the hole to allow for the passage of water.
wherein a potentiometer is integrated into a valve within the user's faucet and is attached in series to the positive leads of the primary coils to regulate the temperature normalcy and the flow of water desirable at any given moment.
wherein only one water pipeline is constructed to facilitate the flow of water which eliminates the cost of unnecessary labor and materials and eliminates the additional amount of space needed for the construction of separate water pipelines.

2. A system according to claim 1, wherein one water pipeline having one faucet valve has the ability to control the flow of water and the temperature setting.

3. A system according to claim 1, wherein the two conically wound primary coils are wound at 60° inclinations from the apexes to the bases and face one another in the center of the transformer.
wherein the two adjoining leads of the bases of the primary coils are joined together and attached to the negative lead of the electrical outlet socket.
wherein the two leads of the apexes of the primary coils are joined together and attached to the positive lead of the electrical outlet socket.
wherein the primary coils are wound conically at 60° inclinations in compliance with the geometry of space and the law of the octave of elements of matter.
wherein the electrical potential and the compression of magnetic fluxes multiplies in each octave progression.
wherein each layer of winding of the primary coils begins its winding from the base down to the apex, then continues to begin its winding onto the base of the second layer down towards the apex. All layers are completed based upon this method.
wherein all the magnetic fluxes created by each layer of winding are going from North “the base” to South “the apex” in accordance to the windings of the primary coils.
wherein the compression of magnetic fluxes, electrical potential and intensity of heat multiplies four times in each octave progression.
wherein the power of the compression of magnetic fluxes and electrical potential reaches a maximum of sixty four (64) times at the apexes of the primary coils by the time it reaches the fourth octave.
wherein the two adjoining primary coils are wound; one in a clockwise direction and the other in a counter-clockwise direction creating the maximum amount of magnetic power without violating nature's one way turning direction.

4. A system according to claim 1, wherein two secondary coils wound at one turn cycle next to the apexes of the primary coils are connected to the induction coil assembly and turns the induction coils into a spontaneous incandescent state of heat.
wherein the left secondary coil is wound in a clockwise direction and the right secondary coil is wound in a counter clockwise direction.

5. A system according to claim 1, wherein an assembly of two conically wound induction coils that face one another are wound nine cycle turns at 60° inclinations.
wherein the two adjoining induction coils are wound: One in clockwise direction and the other in counter-clockwise direction creating the maximum amount of magnetic power without violating nature's one way turning direction.
wherein the two adjoining leads of the induction coils in the center of the assembly are connected to the negative poles of the secondary coils, and the two leads of the apexes of the induction coils are connected to the positive poles of the secondary coils.
wherein the two adjoining induction coils are wound conically in nine cycle turns at 60° degree inclinations in compliance with the universal winding used to fulfill the geometry of space and the law of the octave of elements of matter.
wherein the 60° inclination winding accounts for these laws and compresses the magnetic fluxes in each octave progression of the first, second, third, and fourth octaves in direct cube ratio.
wherein the first, second, third, and fourth octave positions are the square and the cube in inverse and direct ratio of the distance from each other. They create the element of magnetism and heat as well as the spectrum of color which is the measure of heat.
wherein the power of the compression of the magnetic fluxes and the electrical potential in the induction coils reaches a maximum of sixty four (64) times at the apexes of the induction coils by the time it reaches the fourth octave.

6. A system according to claim 1, wherein the heating element centering steel shaft of the induction coils turns to the state of maximum incandescent at the two positive ends where the compression of magnetic fluxes has reached the fourth octave and where the currents collide.
wherein the steel shaft is extended about ½″ on both sides beyond the two apexes of the induction coils.
wherein the two ends of the steel shaft reach the maximum incandescent state of heat.
